(19) United States
(12) Patent Application Publication
(10) Pub. No.: US 2013/0330246 A1
(43) Pub. Date: Dec. 12, 2013

(54) MICRO-FLUIDIC DEVICE

(71) Applicant: Charl P. Stemmet, Geleen (NL)

(72) Inventor: Charl P. Stemmet, Geleen (NL)

(73) Assignee: CHEMTRIX B.V., Geleen (NL)

(21) Appl. No.: 13/818,443

(22) PCT Filed: Aug. 24, 2011
(86) PCT No.: PCT/EP2011/004240

§ 371 Date: May 8, 2013

(30) Foreign Application Priority Data
Aug. 24, 2010 (EP) 10008784.0

(51) Int. Cl. B01J 19/00

(52) U.S. Cl. CPC B01J 19/0093
USPC 422/503

(57) ABSTRACT

The present invention relates to a micro-fluidic device comprising a process channel having a top wall, a bottom wall and side walls, the process channel having a height between 0.2 mm and 3 mm, a width between 1.0 and 50 mm and support means within said process channel. The support means extends between the bottom wall and the top wall of the process channel in a direction substantially perpendicularly to the top wall. The micro-fluidic device comprises at least one heat exchange means parallel to the process channel and optionally comprises a static mixing element. The present invention further relates to a kit of parts and a micro-fluidic system comprising such micro-fluidic devices.

The present invention relates to a new design micro-fluidic device, a kit of parts comprising such micro-fluidic devices and a modular system comprising such micro-fluidic devices

Micro-fluidic devices are defined as having at least one dimension in the sub-millimeter region. The word ‘fluidic’ is, in the context of the present invention construed as ‘involving liquid and/or gaseous components, optionally comprising small particles, e.g. micro or nano particles’.

Micro-fluidic devices are known in the art. In WO2004/022233 a modular micro-fluidic system has been described having at least one base board with a plurality of fluidly linked fluid supply apertures, optional intermediate level boards of equivalent construction, a plurality of micro-fluidic modules adapted to be detachably attached to the base board/intermediate boards, each having one or more fluid inlets and/or outlets, and a plurality of fluid connections.

Micro-fluidic systems in which micro fluidic-devices are used are also known in the art. For example WO03/039736 relates to a micro reactor system for the continuous synthesis, which provides defined reaction chambers and conditions for said synthesis, as well as to the uses of said micro reactor in carrying out a chemical reaction. According to WO03/039736, said micro reactor system is of modular design, a processing unit is made up of processing modules which are connected to each other by frictional engagement and the fluid connections in said processing unit can be obtained by the frictional connection of said processing modules.

WO2007/112945 discloses a micro reactor system assembly comprising a stack of at least n process modules, wherein n is an integer equal to or greater than 1, made from a rigid first material and comprising at least one reactive fluid passage for accommodating and guiding a reactive fluid, and at least n+1 heat exchange modules made from a ductile material other than said first material and comprising at least one heat exchange fluid passage for accommodating and guiding a heat exchange fluid, wherein each process module is sandwiched between two adjacent heat exchange modules.

A disadvantage micro-fluidic devices and systems known from the prior art is that scaling-up can only be performed by placing more micro-fluidic devices in parallel. A reason for this is that the pressure drop across a traditional micro-fluidic device increases rapidly when the flow rate through said traditional micro-fluidic device increases.

Another disadvantage of micro-fluidic devices known in the prior art is that a specific chemical reaction requires a specific reactor chip design. Therefore micro-fluidic systems designed and built with micro-fluidic devices known from the prior art are rather inflexible. Rapid scaling up experiments are therefore time consuming and expensive.

Yet another disadvantage of micro-fluidic devices known in the art is that channels might easily get blocked when clogging occurs. This may lead to complete failure of the micro-fluidic device.

It is an object of the present invention to at least partly overcome the above stated disadvantages of micro-fluidic devices known from the prior art.

It is another object of the present invention to provide flexible micro-fluidic devices that can be used as building blocks for micro-fluidic systems.

These objects have been achieved by a micro-fluidic device comprising a process channel having a top wall, a bottom wall and side walls, the process channel having a height between 0.2 mm and 3 mm, preferably between 0.3 mm and 2.5 mm, more preferably between 0.5 mm and 2 mm. The process channel may have a width between 1.0 mm and 50 mm, preferably between 2.0 mm and 40 mm, more preferably between 3.0 mm and 30 mm, more preferably between 5.0 mm and 25 mm, even more preferably between 10 mm and 20 mm.

The height of the process channel is herein understood to be the distance between the bottom wall and the top wall facing the bottom wall. In the cases where the bottom wall is not entirely straight, the height is understood as the maximum distance between the top wall and the bottom wall. Similarly, in the cases where the side walls do not extend substantially perpendicularly to the top wall, the width is understood as the maximum distance between the side walls facing each other.

The process channel comprises support means within said channel. The support means extend between the bottom wall and the top wall in the direction substantially perpendicularly to the top wall. This means that the walls of the support means extend between the bottom wall and the top wall, wherein the support means are free from holes. Thus, the fluid that flows in the process channel flows around the support means.

The micro-fluidic device of the invention comprises at least one heat exchange means parallel to the process channel defined above.

The process channel is arranged for accommodating a process flow, which may comprise a single reactant (for pre-heating of pre-cooling), a mixture of reactants and optionally reaction products for providing further mixing and/or reaction (i.e. residence time)

The channels and support dimensions are determined by the design of the transfer element that is used in the sandblasting or etch techniques to construct channels within the said object if made of glass. Other techniques may be used to define the channel dimensions and support elements depending on the techniques used to construct such devices and of the material of construction. The dimensions of the channels and support structures within the device are created within reasonable tolerances from the design.

In the cases where the sandblasting or etch techniques are used to construct channels, the cross section of the process channel typically has a shape of a trapezoid. The side walls of the trapezoid may be tapered from the top wall to the bottom wall in an angle of e.g. 10-30°. In this case, since the distance between the side walls at the location of the top wall is the largest, this distance is defined as the width of the process channel.

The dimensions of the channels and the support structures in a micro-fluidic device according to the present invention can be measured by standard optical microscopic techniques.

The process channel dimensions are such that the pressure drop across a channel is low, i.e. a factor 10-10000 lower than the pressure drop across a channel of a conventional micro-fluidic device. A low pressure drop enables the use of multiple micro-fluidic devices according to the present invention in series.

The ratio of the volume of the support means to the theoretical volume of the process channel may be chosen to optimize the mixing performance of the micro-fluidic device according to the present invention. The theoretical volume of the process channel is herein understood as the sum of the actual volume of the process channel (the volume in which a fluid can flow in the process channel) and the volume of the support means in the process channel. The theoretical volume can be calculated from the width, height and the length of the process channel. The actual volume of the process channel can be calculated by e.g. the volume of a liquid such as water which the process channel can contain therein. The volume of the support means can then be calculated as the difference between the theoretical volume of the process channel and the actual volume of the process channel. The volume of the support means is preferably 20-75 vol %, more preferably 30-65 vol % and even more preferably 40-60 vol % of the theoretical volume of the process channel.

The support means do not only provide mechanical strength to the micro-fluidic device, but may also influence the hydrodynamics inside the channel, in a positive way, for example enhancing turbulent flow through the process channel.

In fact the process channel may be considered to be a superposition of a number of small channels having dimensions in the sub-millimeter region, for the purpose of the present invention termed as micro-channels. The micro-channels run in parallel and may be intertwined with each other. The number of micro-channels running parallel may be between 1 and 50, preferably between 3 and 25, more preferably between 5 and 15. A single micro-channel may have a height of between, 0.2 mm and 3 mm, preferably between 0.3 mm and 2.5 mm, more preferably between 0.5 mm and 2 mm. The width of a single micro-channel may be between 0.1 mm and 5 mm, preferably between 0.2 mm and 3 mm, more preferably between 0.3 mm and 2 mm, more preferably between 0.5 mm and 1.5 mm, even more preferably between 0.8 and 1.2 mm.

The support means may be considered as (side) wall members of the micro-channels. The consequence of this arrangement may be that when a micro-channel gets obstructed or completely blocked, e.g. due to clogging, the fluid will find its way through another intertwined micro-channel. The pressure drop due to clogging may therefore be limited.

Moreover, the design of the support means can be optimized to influence the hydrodynamics in a channel, to minimize dead volume and chances on clogging of the microchannel.

Preferably the length of the channel of the micro-fluidic device is between 0.1 m and 5 m, more preferably between 0.3 m and 4 m, most preferably between 0.5 m and 3 m.

The process channel may be curved and/or bent in order to fit on a plate having dimensions smaller than the total length of the channel. The plate may be circular (resembling the shape of a wafer in used in semi-conductor industry). The plate may also be rectangular or square having a length of between 5 cm to 50 cm, preferably between 7 cm and 40 cm, more preferably between 10 and 30 cm, even more preferably between 15 cm and 25 cm and a width of between 5 cm to 50 cm, preferably between 7 cm and 40 cm, more preferably between 10 and 30 cm, even more preferably between 15 cm and 25 cm.

The volume of the process channel of the micro-fluidic device preferably is between 0.3 ml and 100 ml, more preferably between 1 ml and 50 ml, most preferably between 3 ml and 25 ml. The volume of a channel of a micro-fluidic device according to the present invention can be measured by filling the complete channel with a fluid of known density and measuring the weight difference before and after filling the channel with the fluid. The volume of the channel can then be calculated by dividing the weight difference by the density of the fluid.

The support means may comprise multiple support elements and the distance between the support elements may be between 0.1 mm and 5 mm, preferably between 0.2 mm and 4 mm, more preferably between 0.5 mm and 3 mm.

The support elements may have an aspect ratio of between 1 and 25, preferably between 2 and 15, more preferably between 3 and 10, more preferably between 4 and 7. The aspect ratio (A.R.) is defined according to Formula 1:

A.R.=d₁/d₂,

### Wherein:

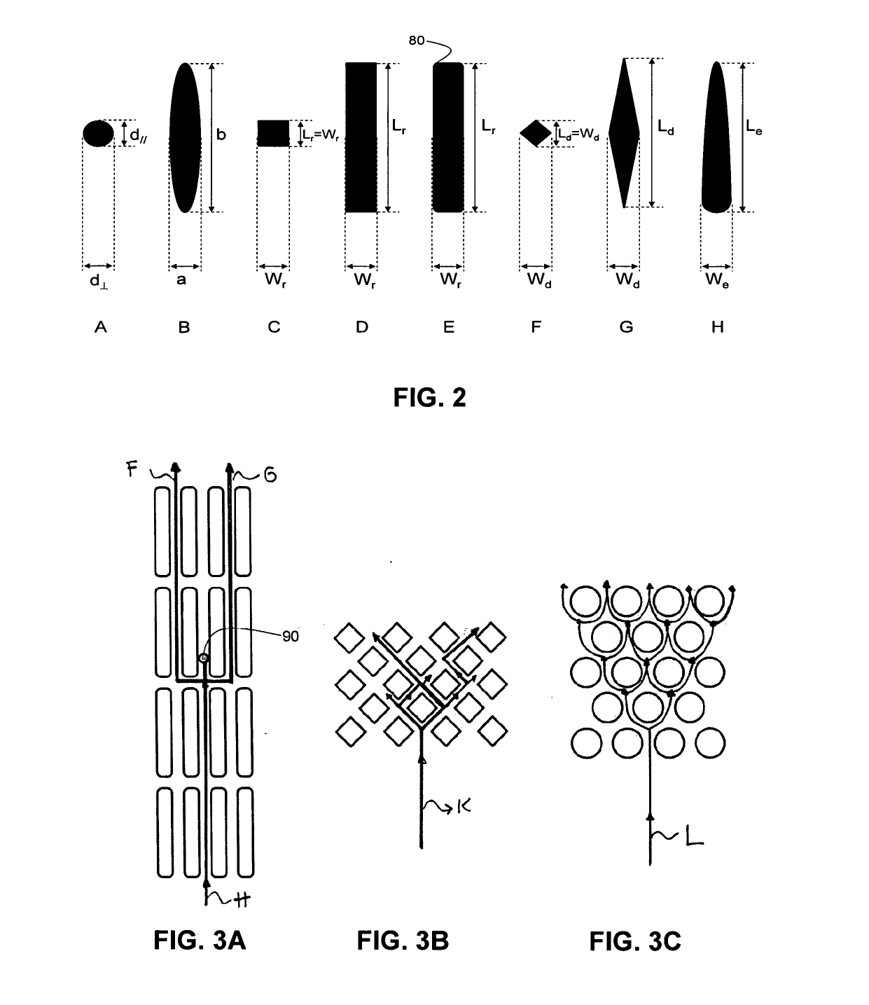

d₁ represents the largest dimension of the support elements in a first direction; and d₂ represents the largest dimension of the support elements in a second direction. The first direction and the second direction are in a plane parallel to the top wall of the process channel. The second direction may be substantially perpendicular to the first direction. For example, the aspect ratio of a rectangular support element is calculated by dividing the length of the support element by the width of the support element. The aspect ratio of an elliptical support element may be calculated by dividing the length of the long axis of the ellipse (b) by the length of the short axis of the ellipse (a). More examples will be given in the detailed description of FIG. 2.

In one particularly preferred embodiment, a micro-fluidic device is provided comprising a process channel having a top wall, a bottom wall and side walls, the process channel having a height between 0.2 mm and 3 mm, a width between 1.0 and 50 mm and support means within said process channel, the support means extending between the bottom wall and the top wall of the process channel in a direction substantially perpendicularly to the top wall, the micro-fluidic device comprising at least one heat exchange means parallel to the process channel, wherein the volume of the support means is 20-75 vol %, preferably 30-65 vol % and more preferably 40-60 vol %, of the sum of the volume in which a fluid can flow in the process channel and the volume of the support means in the process channel, wherein the process channel comprises between 1 and 50 micro-channels having a height of between 0.2 mm and 3 mm and a width between 0.1 mm and 5 mm, the support means being wall members of the micro-channels, and wherein the length of the process channel is between 0.1 and 5 m, wherein the process channel has a volume of between 0.3 and 100 ml, and wherein the support means comprise multiple support elements, and wherein the distance between the support elements is between 0.1 and 5 mm. Preferably the support elements comprise a long dimension having a size of between 0.1 and 50 mm and a short dimension having a size of between 0.1 and 5 mm, and wherein the size of the long dimension is larger than the size of the short dimension, and wherein the support elements are arranged in the process channel such that the long dimension of the support elements is parallel to a length axis of the process channel, and wherein the support elements have an aspect ratio of between 1 and 25.

The support elements may have different shapes like rectangular, diamond, oval, eye-shaped, elliptical or cylindrical. It will be appreciated that the shapes of the support elements referred herein are the shapes of the support elements seen from the top wall, defined by the walls of the support elements extending substantially perpendicularly to the top wall.

In the case that the support elements have a cylindrical shape, preferably the diameter ranges between 1 mm and 7 mm, preferably between 1.5 and 6 mm, more preferably between 2 mm and 5 mm. The height of the support elements is equal to the height of the process channel.

The support elements may comprise a long dimension (e.g. length) having a size of between 0.1 mm and 60 mm, preferably between 1 mm and 50 mm, more preferably between 5 mm and 50 mm and a short dimension (e.g. width) having a size of between 0.1 mm and 5 mm, preferably between 0.2 mm and 3 mm, more preferably between 0.5 mm and 1 mm. The size of the long dimension is larger than the size of the short dimension. The support elements may be arranged in the process channel such that the long dimension of the support elements is parallel to the length axis of the process channel. These supports may also have rounded corners to avoid crack initiation sites within the supports.

The design of the support elements may either decrease the dead volume of the micro-fluidic device by the creation of a laminar boundary layer that extends further downstream along the support element, or by creating turbulence in the process channel. Support element designs supporting the first mechanism minimize the dead volume at any flow rate and are therefore preferred.

The support element may be randomly arranged in the process channel, or in a grid array, preferably in a staggered grid array. An advantage of random arrangement or the staggered grid array arrangement of the support element is that the fluid passages through said micro-channels are intertwined, even without one or more micro-channels being blocked. Such a design may lead to better mixing of the fluids passing through the process channel. This design may also lead to a narrower residence time distribution.

The fluidic device may further comprise a static mixing element. Such devices enable mixing of components, e.g. reactants in a chemical reaction, before the reaction takes place in a residence time section of the micro-fluidic device and micro-fluidic system built with it. Such devices may also be used in micro-fluidic systems, wherein a third, fourth or further reactant needs to be added after a certain amount of time has lapsed after mixing of and reaction between a first and a second reactant.

Preferably, the static mixing element comprises at least two inlets and a mixing part. The mixing part is connected to the at least two inlets and to the process channel of the micro-fluidic device.

In an embodiment, the at least two inlets comprise at least a second process channel and a third process channel, both process channels having a height between 0.2 mm and 3 mm, preferably between 0.3 mm and 2.5 mm, more preferably between 0.5 mm and 2 mm, a width between 0.5 mm and 50 mm, preferably between 1.0 mm and 40 mm, more preferably between 1.5 mm and 30 mm and support means. In this embodiment, the mixing part of the static mixing element comprises a fourth process channel having staggered oriented ridges.

The microfluidic device of the present invention may be built by combining plates that contain different functionalities (like for example a micro reactor, heating or cooling means), which plates are preferably fused together.

The micro-fluidic device comprises at least one plate containing the process channel, and preferably two plates containing heat exchange channels, enabling a heat exchange fluid to be passed through it, and wherein the at least one plate containing the process channel is sandwiched between the two plates containing the heat exchange channels.

An advantage of this embodiment is that heat-exchange is optimized by optimal surface contact between the heat-exchange plates and the at least one plate comprising the process channel (i.e. process plate), and that the microfluidic device can be operated as an individual process channel in a microfluidic system.

Optionally the micro-fluidic device may comprise end plates.

The process channels may also be provided for in two mirror imaged plates placed on top of each other, thus doubling the height of the process channel. A micro-fluidic device according to the present invention therefore comprises between 3 to 6 plates, which are preferably fused together.

In an embodiment, the heat exchange means comprise conducting heat exchange elements.

The micro-fluidic device according to the present invention is made of any suitable material, for example glass, metals or metal alloys (e.g. steel, hastelloy), ceramics, fused silica, silicon carbide (SiC), silicon carbide coated graphite. In a preferred embodiment, the micro-fluidic device according to the present invention is made of glass or fused silica. The use of glass or fused silica has the advantage that reactions and microfluidic devices can be followed by visual inspection, that the reactors are chemically inert. Using fused silica as a reactor material has the advantage (over the use of glass) that fused silica is translucent in the infra-red (IR) wavelength region. This enables IR-spectroscopic analysis during operation of the micro-fluidic device. It also enables the use of IR-heaters, which may directly heat the process flow by irradiation instead of conduction.

The present invention also relates to a kit of parts comprising:
a. at least one micro-fluidic device comprising a process channel having a top wall, a bottom wall and side walls, the process channel having a height between 0.2 mm and 3 mm, a width between 1.0 and 50 mm and support means within said process channel, the support means extending between the bottom wall and the top wall of the process channel in a direction substantially perpendicularly to the top wall, wherein the micro-fluidic device further comprises at least one heat exchange means parallel to the process channel;
b. at least one micro-fluidic device comprising a process channel having a top wall, a bottom wall and side walls, the process channel having a height between 0.2 mm and 3 mm, a width between 1.0 and 50 mm and support means within said process channel and having a static mixing element, the support means extending between the bottom wall and the top wall of the process channel in a direction substantially perpendicularly to the top wall, wherein the micro-fluidic device further comprises at least one heat exchange means parallel to the process channel;
c. at least one sealing means;
d. a holder and a clamping means

In a preferred embodiment, the kit of parts comprises micro-fluidic devices a and b, both having a process channel preferably having a height between 0.3 mm and 2.5 mm, more preferably between 0.5 mm and 2 mm, and a width preferably between 2.0 mm and 40 mm, more preferably between 3.0 mm and 30 mm, more preferably between 5.0 mm and 25 mm, even more preferably between 10 mm and 20 mm and support means.

Preferably, the kit of parts further comprises at least one heat exchange module. The heat exchange modules may be required for pre-heating the reactants and/or cooling the reaction product. The heat-exchange modules may comprise micro-fluidic devices resembling micro-fluidic device [a].

The kit of parts may comprise micro-fluidic devices [a], having process channels with different sizes. For examples, the kit of parts comprises at least one micro-fluidic device [a] having a process channel with a volume of between 0.3 ml and 10 ml, preferably between 0.5 ml and 5 ml, more preferably between 1 ml and 3 ml. The kit of parts further comprises at least one micro-fluidic device [a] having a process channel with a volume of between 0.3 ml and 100 ml, preferably between 1 ml and 50 ml, more preferably between 3 ml and 25 ml.

Similar, the kit of parts may comprise micro-fluidic devices [b], having process channels with different sizes, as given above.

The micro-fluidic devices with small process channel volumes, may be used for lab-scale experiments and production, while the micro-fluidic devices with larger process channel volumes may be used for scaling-up and even large scale production purposes.

The kit of parts may further comprise at least one connection means, for connecting an outlet of a micro-fluidic device with an inlet of a next micro-fluidic device. Such a connection means may comprise a plate with at least one recess for accommodating a sealing means, for example O-rings. The connection means may further comprise holes through the entire plate, arranged such that an outlet of a micro-fluidic device may be fluidly connected with an inlet of a next micro-fluidic device.

An advantage of such connection means is that it increases the flexibility of the kit-of parts, because the inlets and outlets of the micro-fluidic devices can be standardized. This means that all inlets and outlets of the micro-fluidic devices are made such that they are accessible from both sides of the micro-fluidic device (in practice by holes through the entire micro-fluidic device at the beginning or the end of a process channel). The micro-fluidic devices may also comprise holes through the entire device which are not connected to a process channel. Such holes can be used to fluidly connect other modules in the micro-fluidic system.

The connection plate may also block process channels that do not have to be connected to the next micro-fluidic device.

The connection plate may be made of any suitable material, for example glass, fused silica, metals or metal alloys (e.g. steel, hastelloy) and polymeric materials.

Preferably the connection plate is made of a material that is resistant against aggressive (e.g. corrosive) chemicals. More preferably the connection plate is manufactured of a polymeric material; the material for example comprises an epoxy polymer or polyetheretherketone (PEEK). PEEK is most preferred as a material for the connection plate.

Preferably the sealing means is of a chemically resistant, preferably elastic, material, for example comprising a perfluoroalkane polymer, preferably perfluoroethylene, e.g. Perlast® or Kalrez®. The sealing means may comprise at least one O-ring.

An advantage of this kit of parts is that it offers flexibility in micro-fluidic system design. The mentioned elements of the kit of parts may be considered to be flexible building blocks and may be combined in any desired way.

Another advantage is that scaling up experiments may be relatively quickly performed. No specially designed micro-fluidic device is required for a specific chemical reaction.

Yet another advantage of the kit of parts according to the present invention is that no additional tubing to connect micro-fluidic devices to each other is required, which in combination with the used materials for the connection means and the sealing means enable building a micro-fluidic system that can withstand high temperatures, up to 250° C., in combination with high pressures, up to 40 bar.

The kit of parts may be used to design a micro-fluidic system for a specific type of reaction to be performed. Multiple components may be mixed at any desired time-intervals by combining micro-fluidic devices (b), also termed mixing modules (M), with micro-fluidic devices (a), also termed residence time modules (R), in a customized way.

The connection means and sealing means may be used to establish fluid tight connections between the inlets and outlets of the different micro-fluidic devices.

All modules (process modules and heat exchange modules) are designed such that the outer dimensions of the modules are substantially equal in size. The edges of the modules may comprise holes for establishing fluid connections.

For example, the heat exchange modules may comprise holes at the same positions than the inlets and the outlets of the process modules, such that a fluid connection between the outlet and the inlet of two sequential process modules may be established, through a small channel through the heat exchange module.

The design of the modules may also be such that all inlets and outlets of the process modules are on one side of the modules and the inlets and outlets of the heat exchange modules are on the opposite side. The advantage of this is that separate process streams and streams of heat-exchange fluids may be easily established.

After use, the micro-fluidic system can be easily dismantled and the separate process modules and heat exchange modules can be easily cleaned. The micro-fluidic devices making up the micro-fluidic device may then be used again in any configuration for performing the same or a different reaction.

The kit of parts offers a tool-kit for easy and flexible reactor assembly for a wide variety of reactions. The kit of parts is easy to use and easy to maintain.

The present invention also relates to a micro-fluidic system comprising:
a. at least one micro-fluidic device comprising a process channel having a top wall, a bottom wall and side walls, the process channel having a height between 0.2 mm and 3 mm, a width between 1.0 and 50 mm and support means within said process channel, the support means extending between the bottom wall and the top wall of the process channel in a direction substantially perpendicularly to the top wall, wherein the micro-fluidic device further comprises at least one heat exchange means parallel to the process channel;
b. at least one micro-fluidic device comprising a process channel having a top wall, a bottom wall and side walls, the process channel having a height between 0.2 mm and 3 mm, a width between 1.0 and 50 mm and support means within said process channel and having a static mixing element, the support means extending between the bottom wall and the top wall of the process channel in a direction substantially perpendicularly to the top wall, wherein the micro-fluidic device further comprises at least one heat exchange means parallel to the process channel;
c. at least one sealing means;
d. a holder and a clamping means.

A stack of micro-fluidic devices a and b may be formed, and brought into fluid connection with each other. Sealed (i.e. fluid tight) connections between an outlet of the process channel of a micro-fluidic device and an inlet of the process channel of the next micro-fluidic device may be established by providing a sealing means between said outlet and said inlet and a clamping force provided for by the clamping means.

The micro-fluidic system may further comprise at least one connection means, for connecting an outlet of a micro-fluidic device with an inlet of a next micro-fluidic device. Such a connection means has been previously described.

Fluid tight connections between heat exchange channels of subsequent micro-fluidic devices may be made in a similar way.

Another aspect of the present invention provides a kit of parts comprising at least two micro-fluidic devices according to any one of claims; at least one sealing means; a holder and a clamping means, wherein
the kit of parts further comprises at least one connection means and at least one positioning means for the sealing means,
the positioning means comprises at least one hole for accommodating the sealing means and
the connection means comprises a hole and
the hole of the connection means and the hole of the positioning means are arranged for fluidly connecting an outlet of a micro-fluidic device with an inlet of a next micro-fluidic device when the kit of parts is in operation.

Preferably the micro-fluidic system comprises micro-fluidic devices a and b, both having a process channel preferably having a height between 0.3 mm and 2.5 mm, more preferably between 0.5 mm and 2 mm, and a width preferably between 2.0 mm and 40 mm, more preferably between 3.0 mm and 30 mm, more preferably between 5.0 mm and 25 mm, even more preferably between 10 mm and 20 mm, and support means.

Preferably the micro-fluidic system is designed such that all reactants may be preheated in the system, before being mixed together and allowing them to react. This may be achieved by arranging at least one residence time module (with integrated heat exchange, i.e. a micro-fluidic device comprising heat exchange plates) for each participating reactant as the first modules in the micro-fluidic system. After that, a mixing module may be arranged to mix the reactants and allow the reaction to be started. After the mixing of the (initial) reactants, residence time modules may be arranged in series in order to determine the reaction time. Additional reactants may be mixed with the reacting mixture at a later stage. The additional reactants may also be preheated. Before leaving the micro-fluidic system, the reaction mixture might be cooled down to room temperature. The design of the heat exchange may be such that reaction heat (if the reaction is exothermic) is used to pre-heat reactants.

The above described principle is also termed “cold in/cold out” and has the advantage that the heating and cooling steps do not need to be performed in separate/different holders, requiring tubing between a first holder comprising pre-heating modules, a second holder comprising process modules (mixing and reaction) and a third holder comprising cooling modules for cooling the reaction product.

Preferably the above described processes can be incorporated in a single holder, thus eliminating the use of tubing and connectors, which in turn reduces the risk of failure of the system, in particular when operated at a high temperature (e.g. up to 250° C.) and a high pressure (e.g. up to 40 bar).

A similar arrangement may be used to establish pre-cooling of the reactants and/or heating of the final reaction product, for example when optimal reaction conditions lie below room temperature and/or the reaction is endothermic, resulting in a product at a temperature below room temperature.

The present invention also relates to the use of the micro-fluidic system described above, for performing scaling up chemical reactions. The micro-fluidic system may for example be used for scaling up reactions involving aggressive reactants or reactions involving sensitive reactants. An important use if the micro-fluidic systems according to the present invention is the scaling up and manufacture of pharmaceuticals.

The invention will now be explained in more detail with reference to the following figures:

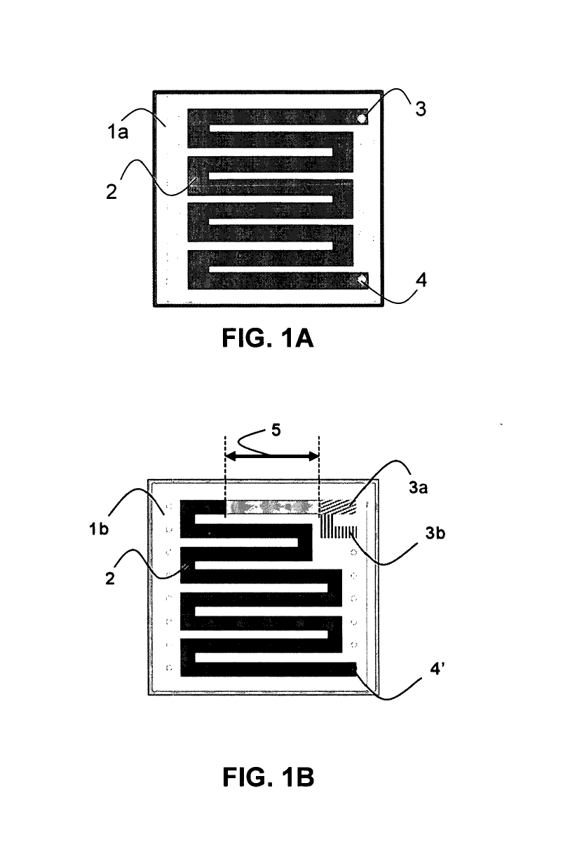

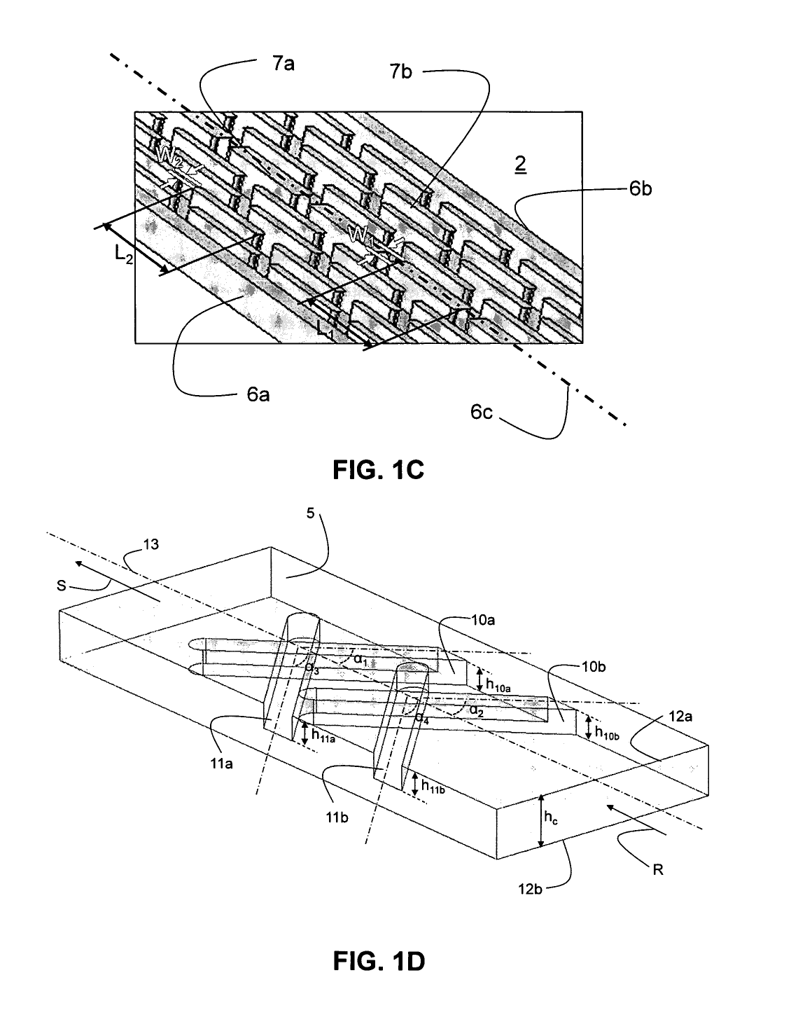

FIG. 1A shows a schematic representation of a micro-fluidic device without static mixer.

FIG. 1B shows a schematic representation of a micro-fluidic device with a static mixing element.

FIG. 1C shows a schematic representation of a detail of a process channel 2 of the micro-fluidic device shown in FIGS. 1A and 1B.

FIG. 1D shows a schematic representation of a detail of the mixing element shown in FIG. 1B.

FIG. 2 schematically shows several shapes of support elements

FIG. 3A schematically shows an arrangement of support elements inside the process channel.

FIG. 3B schematically shows an embodiment of a staggered grid array arrangement of support elements.

FIG. 3C schematically shows and embodiment of a staggered grid array arrangement of support elements

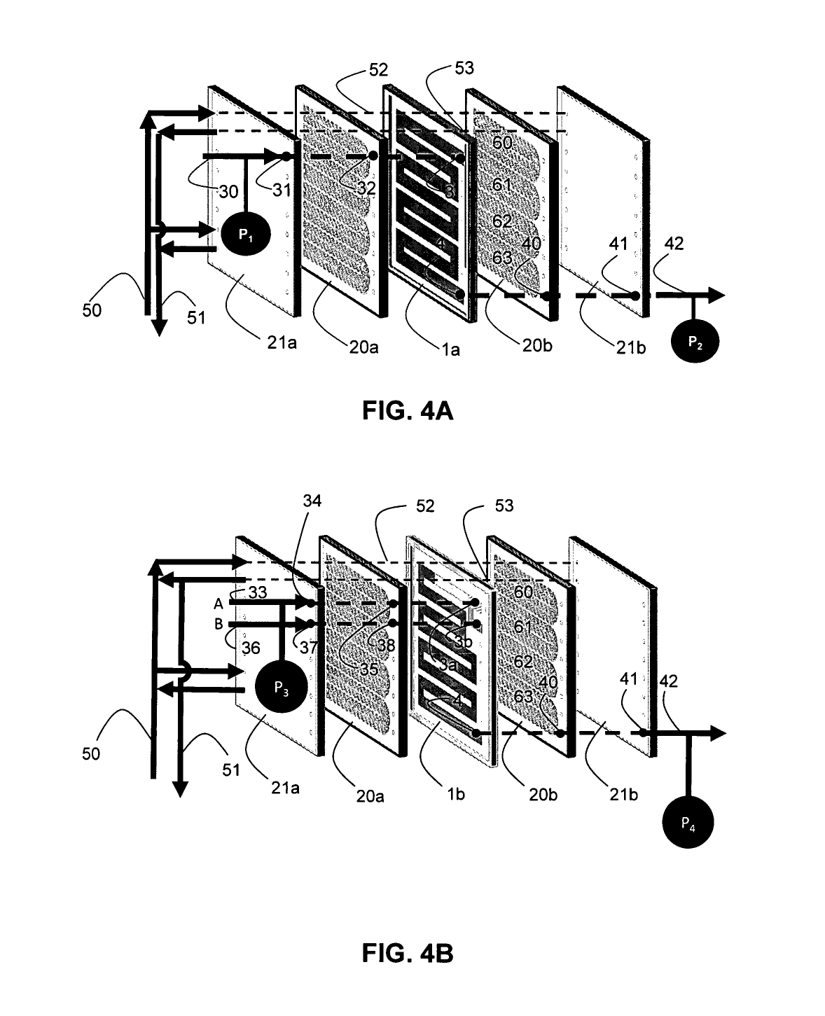

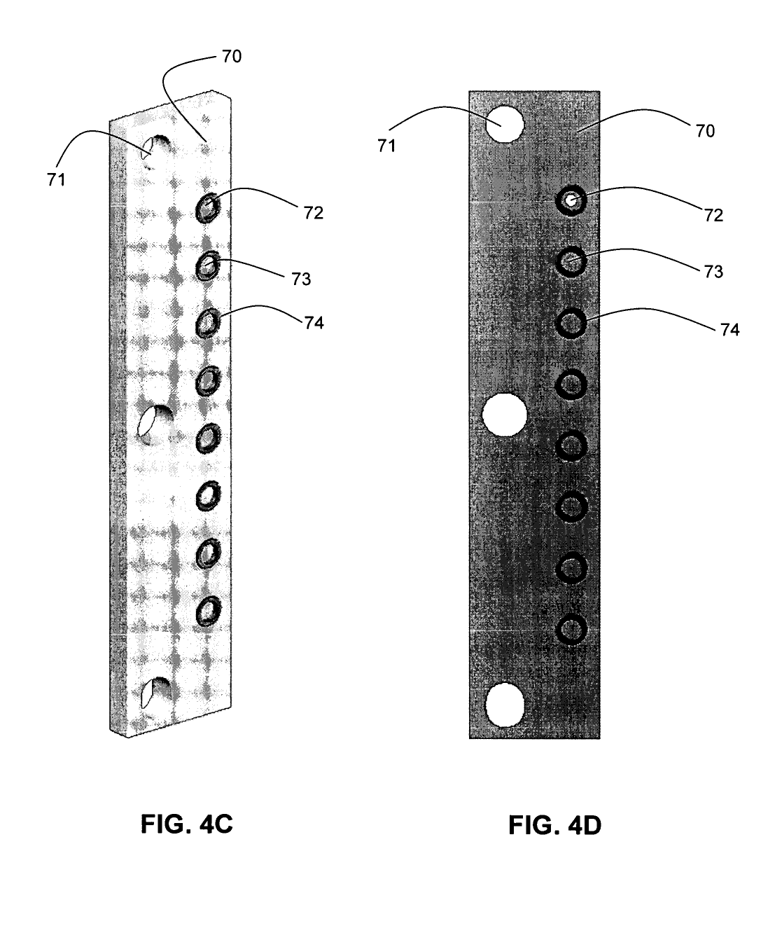

FIG. 4A schematically shows the build-up of a single micro-fluidic device shown in FIG. 1A, wherein the plate comprising the process channel is sandwiched between two heat-exchange plates and two end-plates.

FIG. 4B schematically shows the build-up of a single micro-fluidic device shown in FIG. 1B, wherein the plate comprising the process channel and the mixing section is sandwiched between two heat-exchange plates and two end-plates.

FIG. 4C schematically shows a 3D view of a connection means which may be a part of the kit of parts according to the present invention.

FIG. 4D schematically shows a top view of the connection means shown in FIG. 4D

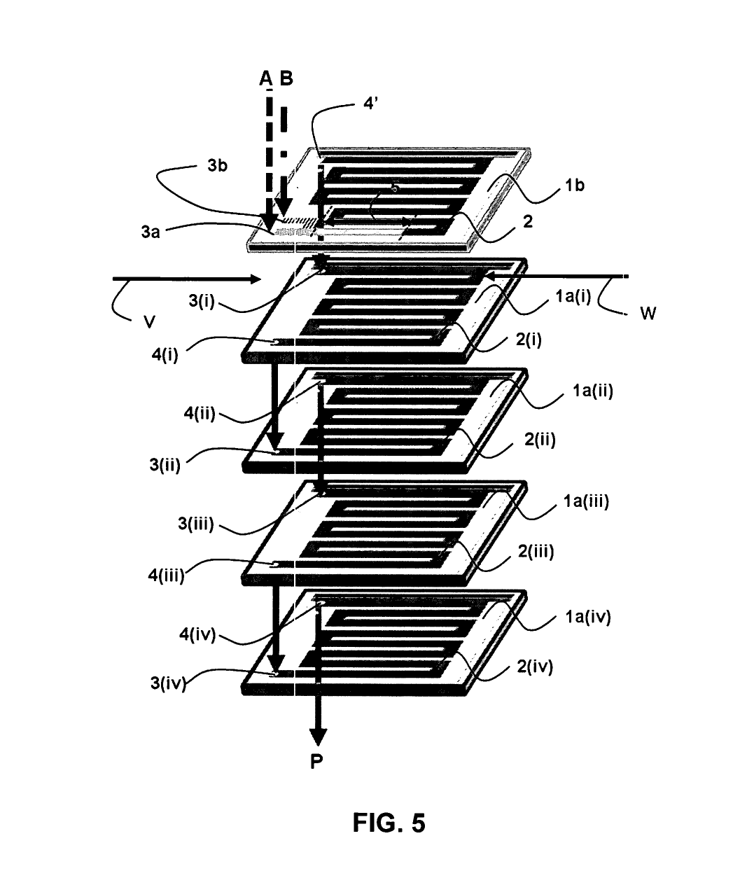

FIG. 5 schematically shows an example of a micro-fluidic system design comprising one micro-fluidic device with a mixing element and 4 without mixing elements, for performing a reaction comprising two reactants: A+B→P

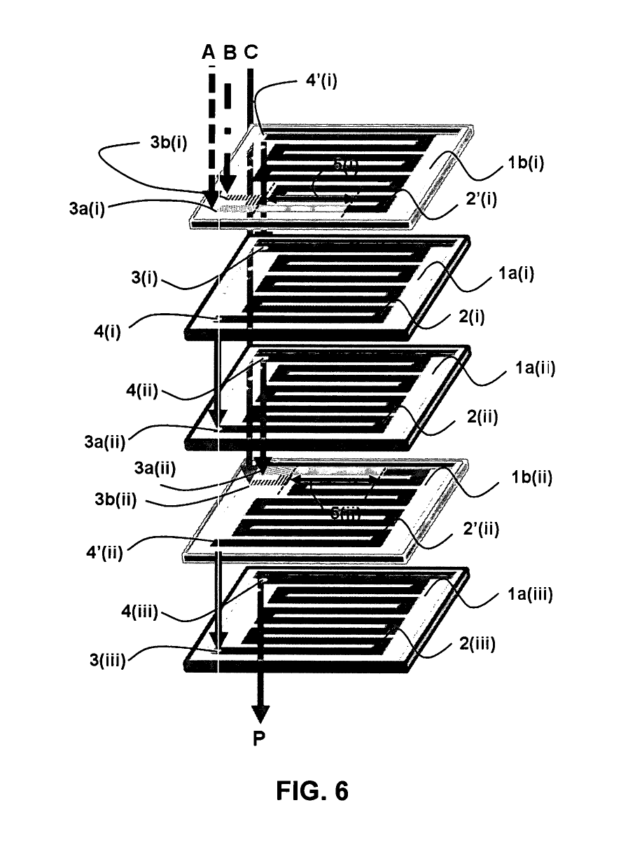

FIG. 6 schematically shows an example of a micro-fluidic system design comprising 2 micro-fluidic devices with a mixing element and 3 without mixing elements, for performing a reaction comprising three reactants that are not simultaneously mixed: A+B→I; and I+C→Q

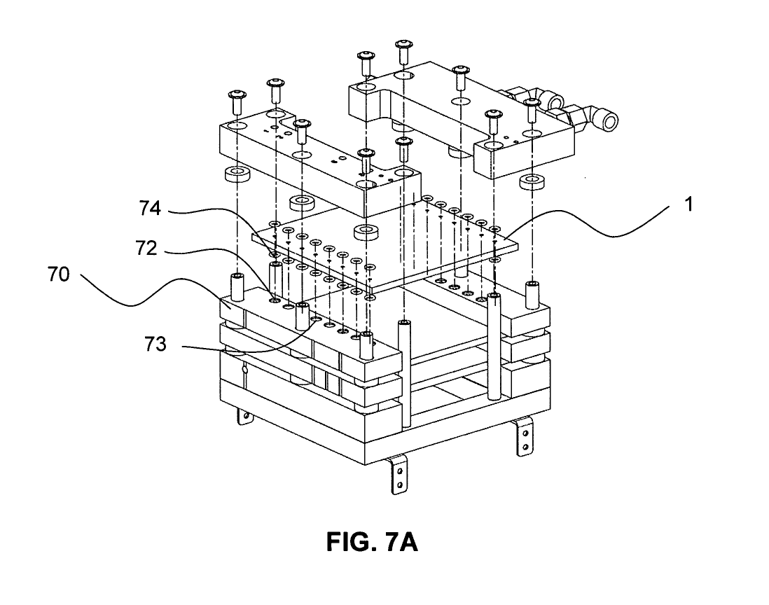

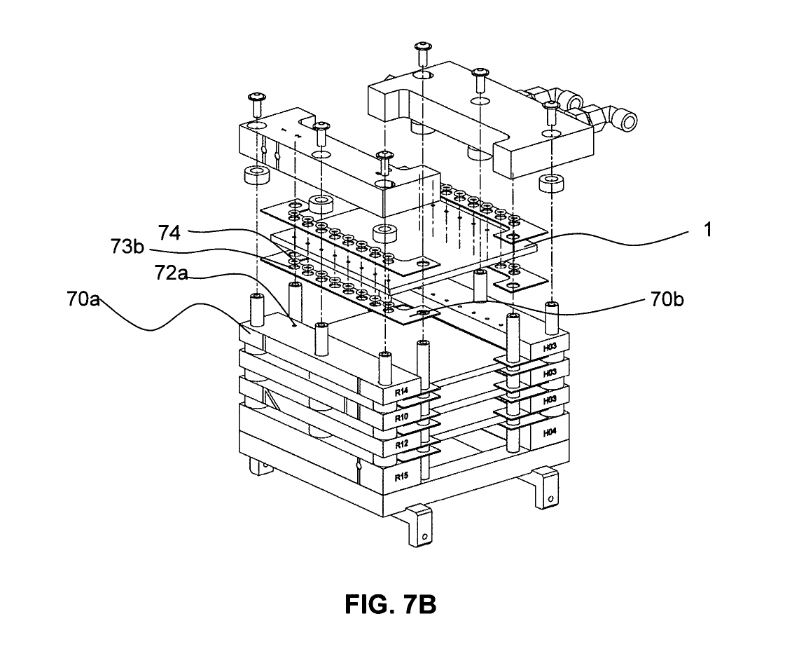

FIG. 7A schematically a view of the kit of parts according to the present invention.

FIG. 7B schematically shows a further view of the kit of parts according to the present invention.

FIG. 1A shows a schematic representation of a micro-fluidic device 1a according to the present invention, comprising a process channel 2 having an inlet 3 and an outlet 4.

FIG. 1B shows a schematic representation of a micro-fluidic device 1b according to the present invention, comprising a process channel 2 having an inlet 3a and another inlet 3b and an outlet 4′. Both inlets 3a and 3b are connected with a mixing section 5, which is connected to the process channel 2.

An example of the interior of process channel 2 of both the micro-fluidic devices 1a and 1b is shown in FIG. 1C. FIG. 1C shows the process channel 2 having substantially parallel opposite walls 6a and 6b and a substantially parallel and longitudinal axis 6c. The interior of the process channel according to this example further comprises supporting elements 7a and 7b as supporting means. Supporting elements 7a of this example are aligned along the axis 6c and have a length L₁ and a width W₁. Supporting elements 7b are aligned substantially parallel to the axis 6c (and hence substantially parallel to walls 6a and 6b) and have a length L₂ and a width W₂. The lengths of supporting elements 7a and 7b are substantially equal, but are not necessarily exactly the same (i.e. L₁≈L₂). The width of supporting elements 7a may be substantially larger than the width of supporting elements 7b (i.e. W₁>W₂). The height of the walls 6a and 6b and the height of the supporting elements 7a and 7b are substantially the same.

FIG. 1D shows a schematic representation of the interior of the mixing section 5 shown in FIG. 1B. The mixing section according to this example is a static mixer section comprising staggered oriented ridges 10a, 10b, 11a and 11b. The ridges are arranged such that they protrude from the bottom wall 12b of the mixing section 5 (i.e. ridges 10a and 10b) or from the ceiling wall of the mixing section 5 (i.e. ridges 11a and 11b). The ridges are arranged at angles α₁, α₂, α₃ and α₄, with axis 13 respectively. Angles α₁, α₂, α₃ and α₄ are selected independently of one another and range from 5° to 85°, preferably from 15° to 75°, more preferably from 30° to 60°, even more preferably between 40° and 50°.

The ridges may have a height which is between 5% and 95% of the height of the process channel, preferably between 10% and 90%, more preferably between 25% and 75% of the height of the process channel. In other words the ratio of the heights of the ridges and the height of the process channel (i.e. h₁₀ₐ/h_{c}, h_{10b}/h_{c}, h₁₁ₐ/h_{c}, h_{11b}/h_{c}, respectively) may be between 0.05 and 0.95, preferably between 0.1 and 0.9, more preferably between 0.25 and 0.75. Hence, the heights of the ridges 10a, 10b, 11a and 11b are different from the height of the process channel, unlike the supporting elements. The heights of the ridges 10a, 10b, 11a and 11b may be the same or different.

Different staggered oriented ridges designs are possible, which may improve the mixing efficiency. One example of staggered oriented ridges may be found in “Research on staggered oriented ridges static micromixers”, X. Fu, et al., Sensors and Actuators, 8114, (2006), p 618-624, which is hereby incorporated by reference.

With the staggered oriented ridges configuration a high mixing efficiency may be obtained over a relatively small mixing length. Therefore the contribution of the mixing section to the overall pressure drop across the micro-fluidic device is small.

The design of the mixer is such that the ridges 10a and 11a, respectively 10b and 11b cross, restricting flow between them. The restrictions are not symmetrical on either side of the process channels: The ridges 10b and 11b have a slight offset (Δx) with respect to each other. The same holds for ridges 10a and 11a.

The static mixer works as follows: a fluid-stream flows in a direction indicated with arrows R and S. The right part of the lower half of the stream is guided to the left-hand side of the process channel by ridge 10b, where it is mixed with the lower left-hand part of the fluid stream. The left part of the upper half of the stream is guided to the right-hand side of the process channel by ridge 11b, where it is mixed with the upper right-hand part of the fluid stream.

By repeating this a number of times, twice in the current example, the fluid stream is mixed.

The design of the supporting elements in the process channel of the micro-fluidic device according to the present invention is of great importance. Carefully chosen designs may reduce the dead volume of the process channel and hence reduce the residence time distribution of a reacting fluid mixture flowing through the process channel.

The aspect ratio (A.R.) of the supporting elements as shown in FIG. 2 may be calculated as follows:

| | |
|---|---|
| FIG. 2A (circular) | A.R. = d_{//}/d_{⊥} = 1; |
| FIG. 2B (elliptical) | A.R. = b/a; |
| FIG. 2C (square) | A.R. = Lᵣ/Wᵣ − Wᵣ/Wᵣ = 1; |
| FIG. 2D-E (rectangular) | A.R. = Lᵣ/Wᵣ; |
| FIG. 2F-G (diamond) | A.R. = L_{d}/W_{d} |
| FIG. 2H (eye shaped) | A.R. = Lₑ/Wₑ. |

The reduction of the dead volume of a process channel may be accomplished by designing the support elements such that during operation a laminar boundary layer along the supporting element is formed which boundary layer extends further downstream than would be the case when conventional (e.g. rectangular) supporting elements are used. For this purpose circular, elliptical (oval), diamond shaped or eye-shaped designs may be most suitable (see FIGS. 2A, 2B, 2F, 2G and 2H).

Another way of reducing the dead volume of the process channel may be by creating turbulence behind the supporting elements, which especially works well at moderate to high flow-rates. For this purpose, supporting elements having shapes shown in FIGS. 2C, 2D and 2E are more suitable. FIG. 2E shows that rectangular support elements having rounded corners 80 are also possible. Because in the present examples the micro-fluidic devices are made of glass, rounded corners also prevent stress cracking of the glass.

Furthermore, the mixing efficiency and hence residence time distribution also depends on the arrangement of the supporting elements inside the process channel 2. FIG. 3A schematically shows an arrangement of support elements inside the process channel, which resembles the configuration shown in FIG. 1C. The arrows F and G in FIG. 3A indicate two different fluid pathways, which fluid pathways are considered to represent micro-channels. When an obstruction 90 arises in a micro-channel, the fluid pathway H will change, see arrows F and G, because the micro-channels are intertwined.

More efficient mixing may be obtained forcing fluid pathways through highly intertwined micro-channels. FIGS. 3B and 3C schematically show staggered grid array arrangement of support elements having a diamond shape (FIG. 3B) and a circular shape (FIG. 3C), respectively. The arrows indicated with K and L in FIGS. 3B and 3C, respectively show that the flow meeting a supporting element is divided into two separate partial streams, one going to the left and one going to the right of the supporting element. Further downstream, partial streams may be combined with partial streams originating from different supporting elements. This process repeats itself further downstream such that more efficient mixing is obtained.

FIGS. 4A and 4B schematically show the build-up of micro-fluidic devices according to the present invention. First the micro-fluidic device comprises at least one plate (1a) comprising a residence time channel or at least one plate (1b) also comprising a mixing section (5, see FIG. 1B). The micro-fluidic devices further comprise two heat exchange plates 20a and 20b and two end plates 21a en 21b, respectively. Micro-fluidic devices according to the present invention may be formed by mechanically assembling and/or fusing the plates as shown in FIGS. 4A and 4B.

FIGS. 4C and 4D schematically show a connection means which may be a part of the kit of parts according to the present invention. The connection means 70 may together with the sealing means 74 be inserted between each micro-fluidic device shown in FIGS. 5 and 6 (arrow V in FIG. 5), to establish a fluid tight connection between for example the outlet 4′ of micro-fluidic device 1b and the inlet 3(i) of micro-fluidic device 1a(i), through hole 72 in the connection means 70. The sealing means 74 are arranged in recesses 73 in the connection means 70. Holes 71 are arranged to accommodate a clamping means, for example bolts and nuts.

Similar connections may be established between the other micro-fluidic devices.

FIG. 7A schematically shows a further view of the kit of parts according to the present invention. FIG. 7A shows stacked layers of the micro-fluidic devices 1 according to the present invention connected by means of the connection means 70 of the FIGS. 4C and 4D together with sealing means 74.

As described referring to FIGS. 4C and 4D, the connection means 70 is inserted between two neighboring micro-fluidic devices 1. The connection means 70 has recesses 73 each having a hole 72. The sealing means 74 are to be accommodated in the recesses 73 of the connection means 70.

After assembling, a fluid tight connection is established between neighboring micro-fluidic devices 1 through a hole 72 in the connection means 70.

FIG. 7B schematically shows a further view of the kit of parts according to the present invention. FIG. 7B shows stacked layers of the micro-fluidic device 1 according to the present invention. The micro-fluidic devices 1 are connected by means of a connection means 70a together with sealing means 74 and a positioning means 70b for the sealing means 74.

The connection means 70a is inserted between two neighboring micro-fluidic devices 1. The connection means 70a has a hole 72a. The positioning means 70b has holes 73b. In this embodiment, the sealing means 74 are to be accommodated in the holes 73b of the second positioning means 70b. This allows the sealing means 74 to be placed in appropriate positions in a separate place from the assembly comprising the micro-fluidic devices 1. Placing the sealing means 74 in appropriate positions in the holes 73b of the positioning means 70b and placing the second connection means 70b on the connection means 70a makes the building up of the system easier.

After assembling, a fluid tight connection is established between neighboring micro-fluidic devices 1 through the hole 72a in the connection means 70a and hole 73b in the positioning means 70b.

On the opposite side (arrow W in FIG. 5) of the inlets and outlets a connection means with sealing means may be inserted as a spacer to avoid mechanical stresses when the stack is clamped in a holder or to establish fluid tight connections between successive heat-exchange layers of the microfluidic devices (not shown in the Figures).

By changing the design of the connection means (i.e. the location of the holes), also parallel connections can be established, by connecting all inlets of a stack of micro-fluidic devices and all outlets of the stack. Also combinations of parallel and serial connections can be established without the need of tubing between the micro-fluidic devices.

### EXAMPLES

### Comparative Example A

### Residence Time and Measured Pressure Drop of a Single Conventional Micro-Fluidic Device as a Function of the Flow Rate

A conventional micro-fluidic device made of glass typically has a process channel volume of 5.56 ml and a process channel length of 10 meters. The cross section of a process channel will therefore be about 0.556 mm² and the process channel has at least one dimension in the sub-millimeter region. The cross section of the process channel resembles a trapezoid. The width of the channel, i.e. the maximum width of the channel is the length of the top wall, which is 1.0 mm. The side walls are tapered towards the bottom wall at an angle of around 20°. The height of the channel, i.e. the maximum height of the channel is 0.7 mm. The process channel does not have a support means. The average residence time is calculated by dividing the process channel volume by the flow rate. The pressure drop between the entrance and the exit of the process channel is measured with the aid of two pressure sensors arranged at the inlet and outlet of the conventional micro-fluidic device. The pressure drop is then calculated by subtracting the measured pressure at the out let of the micro-fluidic device from the measured pressure at the inlet of the micro-fluidic device

The results are summarized in Table 1.

TABLE 1
Residence time and pressure drop as a function of the
flow rate in a conventional micro-fluidic device

| | | Pressure |
|---|---|---|
| Flow rate | Residence | drop |
| [ml/min] | time [s] | [mbar] |
| 1 | 340 | 24 |
| 2 | 170 | 42 |
| 5 | 68 | 1520 |
| 7.5 | 45 | 2344 |
| 10 | 34 | 3722 |
| 15 | 23 | 7723 |

Table 1 shows that the pressure drop quickly increases with increasing flow rate. Conventional micro-fluidic devices are not suitable for use in series, certainly not when high flow rates are desired.

### Example 1

### Residence Time and Measured Pressure Drop of a Single Micro-Fluidic Device According to the Present Invention (FIG. 1A) as a Function of the Flow Rate

A micro-fluidic device according to FIG. 1A, made of glass, typically has length of 1.1 m and a cross section of typically 15×1.4 mm² (see FIG. 1.). The volume of the process channel without supporting elements therefore is about 23.1 ml. The actual volume of a process channel typically is around 10 ml, in this particular example 11.3 ml. Therefore the support elements (see FIG. 1C) occupy around 50% of the volume of the process channel. The average residence time is calculated by dividing the process channel volume (11.3 ml) by the flow rate.

The micro-fluidic devices shown in FIGS. 4A and 4B are used to measure the pressure drop across a single micro-fluidic device according to the present invention at a constant temperature.

The micro-fluidic device in this example is a so called residence time module, which is used to provide and/or increase reaction volume (i.e. adding residence time at a constant flow rate).

A feed stream, indicated with arrow 30, is fed through holes 31 and 32 in the first end-plate 21a and the first heat exchange module 20a respectively to the inlet 3 of the process channel 2 of the micro-fluidic device 1a according to the present invention. The stream passes through the process channel 2 of the micro-fluidic device 1a (residence time module) en leaves it at exit 4 of the process channel 2. The stream then passes through holes 40 and 41 in the second heat exchange module 20b and the second end-plate 21b and ends outside the micro-fluidic system, indicated with arrow 42.

The heat exchange modules comprise 4 parallel heat exchange channels, e.g. 60, 61, 62 and 63 for heat exchange module 20b. The parallel heat exchange channels are simultaneously fed with a heat exchange fluid (i.e. a heating or cooling fluid), which is indicated with arrow 50. Dotted line 52 shows that the heat exchange modules 20a and 20b are also operated in parallel: the feed of heat exchange fluid partly passes through the four channels of heat exchange module 20a and partly through the heat exchange module 20b. Dotted line 53 shows the return flow of the upper channels of both heat exchanges modules 20a and 20b respectively. The latter channel being indicated with number 60. The stream indicated with arrow 51 comprises the total return stream of the 8 heat exchange channels operated in parallel.

The pressure drop between the entrance and the exit of the micro-fluidic device is measured with the aid of two omega DPG 120 pressure sensors arranged at the inlet and outlet of the micro-fluidic device, see P₁ and P₂ in FIGS. 4A and P₃ and P₄ in FIG. 4B. The pressure drop across a micro-fluidic device according to FIG. 4A (residence time module) is then calculated as follows: Δp₁=p₁−p₂. The pressure drop across a micro-fluidic device according to FIG. 4B (mixing module) is then calculated as follows: Δp₂=p₃−p₄.

The results are summarized in Table 2.

TABLE 2
Residence time and pressure drop as a function of the
flow rate of water at 25° C. in a micro-fluidic
device according to the present invention (FIGS. 1A and 4A)

| | | Pressure |
|---|---|---|
| Flow rate | Residence | drop |
| [ml/min] | time [s] | [mbar] |
| 5 | 136 | 1.5 |
| 10 | 68 | 3.0 |
| 20 | 34 | 6.5 |
| 50 | 13.6 | 21.7 |
| 100 | 6.8 | 64.3 |
| 200 | 3.4 | 215.9 |

### Example 2

### Residence Time and Measured Pressure Drop of a Single Micro-Fluidic Device According to the Present Invention (FIG. 1B) as a Function of the Flow Rate

In addition to the description given above in Example 1 and referring to FIGS. 1A and 4A, a micro-fluidic device according to FIG. 4B comprises comprises a mixing section 5, typically having a length of 5 cm and in the present case two inlets 3a and 3b for reactants A and B respectively. The process channel 2 typically has length of 1.05 m and a cross section of typically 15×1.4 mm² (see FIG. 1C.). The total volume of the process channel 2 and the mixing section 5 without supporting elements and without staggered oriented ridges is therefore about 23.1 ml. The actual volume of a process channel typically is around 10 ml, in this particular example 11.3 ml. Therefore the support elements and staggered oriented ridges (see FIGS. 1C and 1D) occupy around 50% of the total volume of the process channel and the mixing section. The average residence time is calculated by dividing the process channel volume (11.3 ml) by the flow rate. The pressure drop between the entrance and the exit of the process channel is measured with the aid of two pressure sensors arranged at the inlet and outlet of the micro-fluidic device, as previously described in example 1.

The results are summarized in Table 3.

TABLE 3
Residence time and pressure drop as a function of the
flow rate of water at 25° C. in a micro-fluidic
device according to the present invention (FIGS. 1B and 4B)

| | | Pressure |
|---|---|---|
| Flow rate | Residence | drop |
| [ml/min] | time [s] | [mbar] |
| 5 | 136 | 1.7 |
| 10 | 68 | 3.4 |
| 20 | 34 | 7.6 |
| 50 | 13.7 | 26.1 |
| 100 | 6.8 | 79.4 |
| 200 | 3.4 | 271.0 |

Comparing table 3 with table 2 it can be seen that the total pressure drop across a micro-fluidic device comprising a mixing section according to the present invention as shown in FIG. 1B is larger than the pressure drop across a micro-fluidic device according to the present invention as shown in FIG. 1A.

### Example 3

### Micro-Fluidic System Design for Performing a Reaction Comprising Two Reactants: A+B→P

FIG. 5. shows a schematic representation of a micro-fluidic system comprising one micro-fluidic device 1b according to example 2 and four micro-fluidic devices 1a(i), 1a(ii), 1a(iii) and 1a(iv) according to example 1. Reactants A and B are fed to the inlets 3a and 3b of micro-fluidic device 1b respectively. The reactants are mixed in the mixing section 5 of micro-fluidic device 1b. Then the mixture passes through process channel 2 of micro fluidic device 1b. The mixture leaves micro-fluidic device 1b at outlet 4 and enters the next micro-fluidic device through inlet 3(i), which is a residence time module according to example 1. The mixture thus passes through four residence time modules and the product P leaves the micro-fluidic system at the outlet 4(iv) of the fourth micro-fluidic device according to example 1 (1a(iv)).

In this example, the influence of flow-rate and the total number of modules on the pressure drop and the residence time was determined. The results are shown in Table 4

TABLE 4
Residence time and pressure drop as a function of the flow rate
of water at 25° C. and the total number of micro-fluidic
devices (modules) in series (example of which is shown in FIG. 5)

| | | | Pressure | |
|---|---|---|---|---|
| Flow rate | # | | drop | Residence |
| [ml/min] | modules | Type | [mbar] | time [s] |
| 20 | 5 | 1 M + 4 R | 33.6 | 170 |
| 50 | | (±50 ml)¹ | 112.9 | 68 |
| 100 | | | 336.6 | 34 |
| 20 | 10 | 1 M + 9 R | 66.1 | 340 |
| 50 | | (±100 ml)¹ | 221.4 | 136 |
| 100 | | | 658.1 | 68 |
| 20 | 20 | 1 M + 19 R | 131.1 | 680 |
| 50 | | (±200 ml)¹ | 438.4 | 272 |
| 100 | | | 1301.1 | 136 |

¹M represents a mixing module, i.e. a micro-fluidic device shown in FIG. 1B; R represents a residence time module, i.e. a micro-fluidic device shown in FIG. 1 A.

Table 4 shows that at a desired flow rate of 100 ml/min (6 L/hr) and a residence time of about 2 minutes (required to obtain adequate conversion of A and B into P), 20 modules are required: one mixing module (FIG. 1B) followed in series by 19 residence time modules (FIG. 1A). The total pressure drop across the micro-fluidic system according to this example is 1301.1 mbar.

### Example 4

### Micro-Fluidic System Design for Performing a Reaction Comprising Two Reactants: A+B→I and I+C→Q

FIG. 6. shows a schematic representation of a micro-fluidic system comprising a micro-fluidic device 1b(i) according to example 2 followed by two micro-fluidic devices 1a(i) and 1a(ii) according to example 1, followed a second micro-fluidic device 1b(ii) according to example 2, which is again followed by a third micro-fluidic device 1a(iii) according to example 1. Reactants A and B are fed to the inlets 3a(i) and 3b(i) of micro-fluidic device 1b(i) respectively. The reactants are mixed in the mixing section 5(i) of micro-fluidic device 1b(i). Then the mixture passes through process channel 2′(i) of micro fluidic device 1b(i). The mixture leaves micro-fluidic device 1b(i) at outlet 4′(i) and enters the next micro-fluidic device through inlet 3(i), which is a residence time module according to example 1. The mixture passes through two residence time modules (1a(i) and 1a(ii)). The mixture is then fed to inlet 3a(ii) of a second mixing module 1b(ii) and mixed with a third reactant C, which is fed to inlet 3b(ii) of the second mixing module 1b(ii). The mixture of A, B and intermediate product I is mixed with reactant C in mixing region 5(ii) of the second mixing module 3b(ii). The then obtained mixture passes through process channel 2′(ii) of the second mixing module, leaves the module at the outlet 4′(ii) and enters the fourth and final residence time module at inlet 3(iii). The product Q leaves the micro-fluidic system at the outlet 4(ii) of the third micro-fluidic device according to example 1 (1a(iii)).

This example shows that the modular approach offers flexibility of designing a micro-fluidic system having multiple inlet positions of additional reactants (here: C) at a desired residence time of the original reactants (here A and B). The results are shown in Table 5

TABLE 5
Residence time and pressure drop as a function of the flow rate
of water at 25° C. and the total number of micro-fluidic
devices (modules) in series (example of which is shown in FIG. 5)

| | | | | Residence | |
|---|---|---|---|---|---|
| | | | Pressure | time | Total |
| Flow rate | # | | drop | before | Residence |
| [ml/min] | modules | Type | [mbar] | adding C [s]² | time [s] |
| 20 | 5 | 1 M + 2 R + | 34.7 | 102 | 170 |
| 50 | | 1 M + 1 R | 117.3 | 41 | 68 |
| 100 | | (±50 ml)¹ | 351.7 | 20 | 34 |
| 20 | 10 | 1 M + 4 R + | 67.2 | 170 | 340 |
| 50 | | 1 M + 4 R | 225.8 | 68 | 136 |
| 100 | | (±100 ml)¹ | 673.2 | 34 | 68 |
| 20 | 10 | 1 M + 6 R + | 67.2 | 238 | 340 |
| 50 | | 1 M + 2 R | 225.8 | 95 | 136 |
| 100 | | (±100 ml)¹ | 673.2 | 48 | 68 |
| 20 | 20 | 1 M + 4 R + | 132.2 | 170 | 680 |
| 50 | | 1 M + 14 R | 442.8 | 68 | 272 |
| 100 | | (±200 ml)¹ | 1316.2 | 34 | 136 |

### Example 5

### Comparison Between a Parallel Arrangement of Conventional Micro-Fluidic Devices (See Table 1) and a Modular and Serial Micro-Fluidic System Design According to the Present Invention for Performing a Reaction Comprising Two Reactants: A+B→I and I+C→Q

TABLE 5
Pressure drop as a function of flow rate of water at 25° C. and
residence time for a) parallel configuration of conventional
micro-fluidic devices and b) series configuration of modular
micro-fluidic system according to the present invention

| Conditions | | | | | | |
|---|---|---|---|---|---|---|
| Desired | | | | | | |
| flow | Required | Parallel^{a} | | Series^{b} | | |
| rate | residence | Number | Pressure | Number | | Pressure |
| [ml/ | time | of | drop | of | | drop |
| min] | [s] | devices | [mbar] | devices | Type | [mbar] |
| 50 | 34 | 5 | 3722 | (2.5)→3 | 2 M + 1 R | 73.9 |
| 100 | | 10 | | 5 | 2 M + 3 R | 351.7 |
| 200 | | 20 | | 10 | 2 M + 8 R | 2269.2 |
| 50 | 68 | 10 | 1520 | 5 | 2 M + 3 R | 117.3 |
| 100 | | 20 | | 10 | 2 M + 8 R | 673.2 |

Table 5 shows the total pressure drop across a micro-fluidic system of a) a parallel arrangement of conventional micro-fluidic devices and b) serial arrangement of micro-fluidic devices according to the present invention.

Table 5 also shows that a parallel arrangement of conventional micro-fluidic devices shows a pressure drop across the micro-fluidic system that is independent of the production rate, i.e. flow rate, while the pressure drop across a serial arrangement of micro-fluidic devices according to the present invention increases with increasing production rate.

Table 5 further shows that the serial arrangement of micro-fluidic devices according to the present invention works extremely well when short residence times are required

Parallel reactors (i.e. conventional micro-fluidic devices) cannot be placed in series because of the high pressure drop at relatively low flow-rates. When the production capacity needs to be increased (by placing more reactors in parallel), the operating conditions (e.g. the pressure drop) remain the same.

Series reactors (i.e. micro-fluidic devices) according to the present invention show:
a low pressure drop for a high production capacity and advantages for fast reactions (<1 minute);
an increasing pressure drop with increasing production capacities (and all other design parameters constant);
the use of two types of micro-fluidic devices (i.e. mixing module (FIG. 1B) and residence time module (FIG. 1A)) gives freedom of introduction of additional reactants and (additional) residence time.

The modular approach, offers great flexibility to design reactors based on basically any reaction scheme.

1. A micro-fluidic device (1a) comprising a process channel (2) having a top wall, a bottom wall and side walls, the process channel having a height between 0.2 mm and 3 mm, a width between 1.0 and 50 mm and support means (7a, 7b) within said process channel, the support means extending between the bottom wall and the top wall of the process channel in a direction substantially perpendicularly to the top wall, the micro-fluidic device comprising at least one heat exchange means parallel to the process channel.

2. The micro-fluidic device according to claim 1, wherein the volume of the support means is preferably 20-75 vol %, more preferably 30-65 vol % and even more preferably 40-60 vol %, of the sum of the volume in which a fluid can flow in the process channel and the volume of the support means in the process channel.

3. The micro-fluidic device according to claim 1, wherein the process channel comprises between 1 and 50 micro-channels having a height of between 0.2 mm and 3 mm and a width between 0.1 mm and 5 mm, the support means being wall members of the micro-channels, and wherein optionally the length of the process channel is between 0.1 and 5 m.

4. The micro-fluidic device according to claim 1, wherein the process channel has a volume of between 0.3 and 100 ml

5. The micro-fluidic device according to claim 1, wherein the support means comprises multiple support elements, and wherein the distance between the support elements is between 0.1 and 5 mm, and preferably wherein the support elements comprise a long dimension having a size of between 0.1 and 50 mm and a short dimension having a size of between 0.1 and 5 mm, and wherein the size of the long dimension is larger than the size of the short dimension, and wherein the support elements are arranged in the process channel such that the long dimension of the support elements is parallel to a length axis of the process channel, and wherein the support elements have an aspect ratio of between 1 and 25.

6. The micro-fluidic device according to claim 5, wherein the shape of the support elements is rectangular, diamond-shaped, oval, eye-shaped or elliptical, or wherein the support elements have a cylindrical shape, having a diameter of between 1 and 7 mm and wherein the support elements are arranged randomly, or in a grid array, preferably in a staggered grid array.

7. The micro-fluidic device according to claim 1, wherein the micro-fluidic device further comprises a static mixing element, and wherein preferably the static mixing element comprises at least two inlets (3a, 3b) and a mixing part (5), and wherein the mixing part is connected to the at least two inlets (3a, 3b) and to the process channel (2) of the micro-fluidic device (1b).

8. The micro-fluidic device according to claim 7, wherein the at least two inlets (3a, 3b) comprise at least a second channel and a third channel, both channels having a height between 0.5 mm and 3 mm, a width between 0.5 and 50 mm and support means, and wherein the mixing part (5) of the static mixing element comprises a fourth channel having staggered oriented ridges (10a, 10b, 11a, 11b).

9. The micro-fluidic device according to claim 1, wherein the micro-fluidic device comprises at least one plate containing the process channel, and wherein the heat exchange means comprises a plate containing heat exchange channels, enabling a heat exchange fluid being passed through it, and wherein the at least one plate containing the process channel is sandwiched between two plates containing heat exchange channels.

10. The micro-fluidic device according to claim 1, wherein the micro-fluidic device is made of glass, metal, metal alloy, ceramics, fused silica, silicon carbide, silicon carbide coated graphite, preferably the micro-fluidic device is made of glass or fused silica.

11. A kit of parts comprising:
a. at least one micro-fluidic device according to claim 1;
b. at least one static mixing element, wherein the static mixing element comprises at least two inlets and a mixing part, and wherein the mixing part is connected to the at least two inlets and to the process channel of the micro-fluidic device;
c. at least one sealing means; and
d. a holder and a clamping means.

12. The kit of parts according to claim 11, wherein the kit of parts comprises at least two micro-fluidic devices and at least two static mixing elements having process channels with different sizes.

13. The kit of parts according to claim 11, wherein the kit of parts comprises at least one connection means (70), the connection means comprising a plate having at least one recess (73) for accommodating the sealing means (74), the at least one connection means optionally comprises a hole (72) for fluidly connecting an outlet (4′) of a micro-fluidic device (1b) with an inlet (3(i)) of a next micro-fluidic device (1a(i)).

14. A kit of parts comprising at least two micro-fluidic devices (1) according to claim 1; at least one sealing means (74); a holder and a clamping means, wherein
the kit of parts further comprises at least one connection means (70a) and at least one positioning means (70b) for the sealing means,
the positioning means has at least one hole (73b) for accommodating the sealing means and
the connection means comprises a hole (72a) and
the hole of the connection means and the hole of the positioning means are arranged for fluidly connecting an outlet of a micro-fluidic device with an inlet of a next micro-fluidic device when the kit of parts is in operation.

15. The kit of parts according to claim 13, wherein the connection means is a plate made of a material selected from the group consisting of glass, fused silica, metal, metal alloy and polymeric materials, preferably the connection plate is made of an epoxy polymer or polyetherehterketone (PEEK).

16. A micro-fluidic system comprising:
a. at least one micro-fluidic device according to any claim 1;
b. at least one static mixing element, wherein the static mixing element comprises at least two inlets and a mixing part, and wherein the mixing part is connected to the at least two inlets and to the process channel of the micro-fluidic device;
c. at least one sealing means;
d. a holder and a clamping means;
wherein a stack comprising micro-fluidic devices a and b is formed, and brought into fluid connection with each other, wherein sealed (i.e. fluid tight) connections between an outlet of the channel of a micro-fluidic device and an inlet of the channel of the next micro-fluidic device is established by providing a sealing means between said outlet and said inlet and a clamping force provided for by the clamping means and wherein optionally at least one residence time module is arranged for each participating reactant as the first modules in the micro-fluidic system, followed by a mixing module, allowing the reactants to be preheated or precooled before they are mixed and the reaction is started.

17. Use of the micro-fluidic system of claim 16, for scaling up chemical reactions involving aggressive reactants or reactions involving sensitive reactants.
